(19) United States
(12) Patent Application Publication
(10) Pub. No.: US 2011/0238712 A1
(43) Pub. Date: Sep. 29, 2011

(54) ACTIVE SESSION SEARCH

(75) Inventors: Pavel Dostal, Zelesice (CZ); Hans Rohnert, Munchen (DE); Ivo Sedlacek, Lund (SE)

(73) Assignee: NOKIA SIEMENS NETWORKS OY, Espoo (FI)

(21) Appl. No.: 13/119,224

(22) PCT Filed: Sep. 30, 2009
(86) PCT No.: PCT/EP2009/062680

§ 371 Date: Jun. 1, 2011

(30) Foreign Application Priority Data
Oct. 21, 2008 (GB) 0819312.0

(51) Int. Cl. G06F 17/30

(52) U.S. Cl. 707/811; 707/E17.127

(57) ABSTRACT

A method and apparatus is described in which a server providing group communication maintains document of active group sessions. The group communication server may provide a search capability to identify active group sessions. Alternatively, the group communication server uses a caching entity to provide the search capability to identify active group sessions corresponding to a search request from a user.

The present invention relates to providing search functionality for identifying data on a server and in particular to providing search functionality for identifying active group sessions on a group communication server.

Group communication services are provided in a communication environment and enable multiple users to interact and talk to each other in a group session. The multiple users use a terminal, for example, a mobile phone, to join and participate in a group session. There are several types of group communication available including Push-to-Talk over Cellular (PoC), Instant Messaging (IM), and Converged IP Messaging (CPM).

Conventional systems for implementing group communication do not enable a user to search for particular groups where communication is currently active. For example, if a user is currently in the process of cooking a meal but wishes to ask for advice about an aspect of the cooking process the user will want to find an active cookery group session in order to obtain the advice as soon as possible. However, conventional group communication systems do not enable the user to search for active cookery group sessions in order to obtain the advice they need.

This need to be able to search for active group sessions is applicable to all types of group communication including Push-to-Talk over Cellular (PoC), Instant Messaging (IM), and Converged IP Messaging (CPM).

In conventional group communication systems a Shared Group XML Document Manager Server (XDMS) stores the group definition which includes the subject of the group whilst it is the group communication server that knows which groups are currently active.

An XML Document Manager (XDM) enabler provides functionality to search for data stored in the XDMS as the data is stored as XML documents and can be searched using the protocol Limited XQuery over HTTP. However, even though one can search the XML documents containing the group definitions stored on the XDMS one cannot identify which of those groups has a currently active session.

The group communication server has information regarding the currently active group sessions but the group communication servers do not provide any search functionality that will enable a user to search, based on the group subject, for all active group sessions that relate to a subject the user is interested in.

Therefore, there is a problem with the conventional systems in that a user cannot search and locate all active group sessions corresponding to a particular subject.

According to a first aspect of the present invention there is provided a method comprising: retrieving a group definition summary of an active group session wherein the group definition comprises a group Uniform Resource Identifier and a subject; adding the group definition summary to an XML document; receiving a search request wherein the search request comprises a search parameter and the search parameter comprises at least one subject; and identifying at least one group definition summary in the XML document corresponding to the at least one search parameter.

Accordingly, the present invention advantageously provides search functionality for identifying active group sessions that correspond to a subject specified in a search request. Therefore, the preferred embodiments enable a user to specify a subject and receive an identification of all active group sessions that correspond to the subject where the group communication server performs the search.

The XML document may be a virtual XML document.

The method may further comprise determining at least one inactive group session; and removing the inactive group session from the XML document. Thus, by removing inactive group sessions from the XML document, the XML document can be used to maintain details of currently active group sessions.

The search request may be received from a search proxy and the method may further comprise sending the identified at least one group definition summary to the search proxy.

The search request may be received from a search proxy and the method may further comprise determining a search load and based on the determined search load sending the search request to a caching entity.

The search request may be received from a caching entity and the method may further comprise sending the identified at least one group definition summary to the caching entity.

The at least one subject of the search parameter may comprise a default subject so that all active group sessions can be identified irrespective of the actual subject of each group.

The search parameter may further comprise at least one type of active group session where the type of active group session is any one of a PoC, IM or CPM.

The method may further comprise sending the group definition summary of the one active group session to a caching entity.

The method may further comprise receiving a subscription request from the caching entity to subscribe to the XML document and sending any changes to the XML document to the caching entity.

The method may further comprise determining at least one inactive group session; and sending the determined inactive group session to the caching entity.

The method may further comprise receiving a request for the group definition summary of the active group session from a caching entity; and sending the group definition summary of the active group session to the caching entity.

The method may further comprise receiving a request from the caching entity for inactive group sessions; identifying the inactive group sessions; and sending the identified inactive group sessions to the caching entity.

The method may further comprise receiving a request for the group definition summaries of active group sessions from an aggregation proxy.

In a second aspect of the present invention there is provided a server adapted to retrieve a group definition summary of an active group session wherein the group definition summary comprises a group Uniform Resource Identifier and a subject; add the group definition summary to an XML document; receive a search request wherein the search request comprises a search parameter wherein the search parameter comprises at least one subject; and identify at least one group definition summary in the XML document corresponding to the at least one search parameter.

The server may be any number of a Push to Talk over Cellular server, Instant Messaging server or a Converged IP Messaging server.

The server may further be adapted to identify inactive group sessions and remove the inactive group sessions from the XML document.

In a third aspect of the present invention there is provided a computer program product comprising computer readable code for receiving a group definition summary of an active group session wherein the group definition summary comprises a group Uniform Resource Identifier and a subject; adding the group definition summary to an XML document; receiving a search request wherein the search request comprises a search parameter wherein the search parameter comprises at least one subject; and identifying at least one group definition summary in the XML document corresponding to the at least one search parameter.

In a fourth aspect of the present invention there is provided a method comprising receiving a group definition summary of an active group session wherein the group definition summary comprises a group Uniform Resource Identifier and a subject; caching the at least one group definition summary; receiving a search request wherein the search request comprises a search parameter and the search parameter comprises at least one subject; and identifying at least one group definition summary in the cache corresponding to the at least one search parameter.

Accordingly, the present invention advantageously provides search functionality for identifying active group sessions that correspond to a subject specified in a search request. Therefore, in this embodiment a user is able to specify a subject and receive an identification of all active group sessions that correspond to the subject where a caching entity performs the search.

The method may further comprise requesting the at least one group definition summary of the active group sessions from a server providing group communication.

The method may further comprise sending a subscription request to the server providing the group communication to subscribe to the XML document. The caching entity will therefore automatically receive any changes to the XML document maintained by the server providing the group communication automatically from the server providing the group communication.

The method may further comprise receiving group definition summaries from more than one server providing group communication. The method may further comprise sending a subscription request to more than one server providing group communication. Thus, the caching entity may be used as an aggregation proxy in which it can collate all of the group definition summaries of all of the active group sessions where more than one group communication server is arranged to operate in parallel and each group communication server only maintains an XML document of the active group sessions that group communication server is processing.

The method may further comprise receiving at least one group definition summary of at least one inactive group session; and removing the at least one inactive group session from the cache.

The method may further comprise filtering the at least one group definition summary based on a predetermined parameter.

The method may further comprise determining a search load and based on the determined search load processing the search request in the caching entity or forwarding the search request to the server providing group communication.

The search request may be received from a search proxy and the method may further comprise sending the identified at least one group definition summary in the cache corresponding to the at least one search parameter to the search proxy.

In a fifth aspect of the present invention there is provided a caching entity which is adapted to receive a group definition summary of an active group session wherein the group definition summary comprises a group Uniform Resource Identifier and a subject; cache the at least one group definition summary; receive a search request wherein the search request comprises a search parameter wherein the search parameter comprises at least one subject; and identify at least one group definition summary in the cache corresponding to the at least one search parameter.

In a sixth aspect of the present invention there is provided a computer program product comprising computer readable code for receiving a group definition summary of an active group session wherein the group definition summary comprises a group Uniform Resource Identifier and a subject; caching the at least one group definition summary; receiving a search request wherein the search request comprises a search parameter wherein the search parameter comprises at least one subject; and identifying at least one group definition summary in the cache corresponding to the at least one search parameter.

In a seventh aspect of the present invention there is provided a method comprising a group communication server retrieving a group definition summary of an active group session wherein the group definition summary comprises a Uniform Resource Identifier and a subject; adding the group definition to an XML document; receiving a search request wherein the search request comprises a search parameter and the search parameter comprises at least one subject; and determining a search load; wherein based on the search load the search request is processed by a caching entity or by the group communication server.

Accordingly, the preferred embodiments of the present invention advantageously provide the ability to determine whether a caching entity or a group communication server should process the search based on the search load associated with search request.

The caching entity may process the search request if the search load is above a predetermined threshold; and the method may further comprise receiving at least one group definition summary of the active group sessions; caching the at least one group definition summary; identifying at least one group definition summary in the cache corresponding to the at least one search parameter; and returning the identified at least one group definition summary in response to the search request.

Accordingly, the search request can be processed by a caching entity if the search load is above a predetermined threshold. If the search load is above a predetermined threshold then the performance of the group communication server may be affected if the group communication server processes the search request.

The method may further comprise receiving a group definition summary of an inactive group session; and removing the inactive group session from the cache.

The group communication server may process the search request if the search load is below a predetermined threshold; and the method may further comprise identifying at least one group definition summary in the XML document corresponding to the at least one search parameter; and returning the identified at least one group definition summary in response to the search request.

Accordingly, the search request can be processed by the group communication server if the search load is below a predetermined threshold. If the search load is below a predetermined threshold then performance of the group communication server may be affected if the group communication server processes the search request.

The method may further comprise determining at least one inactive group session; and removing the inactive group session from the XML document.

In an eighth aspect of the present invention there is provided a system comprising a group communication server and a caching entity wherein the system is adapted so that the group communication server retrieves a group definition summary of an active group session wherein the group definition summary comprises a Uniform Resource Identifier and a subject and add the group definition summary to an XML document; receive a search request wherein the search request comprises a search parameter and the search parameter comprises at least one subject; and determine a search load; wherein based on the search load the search request is processed by the caching entity or by the group communication server.

Preferred embodiments of the present invention will now be described, by way of example only, and with reference to the accompanying drawings, in which:

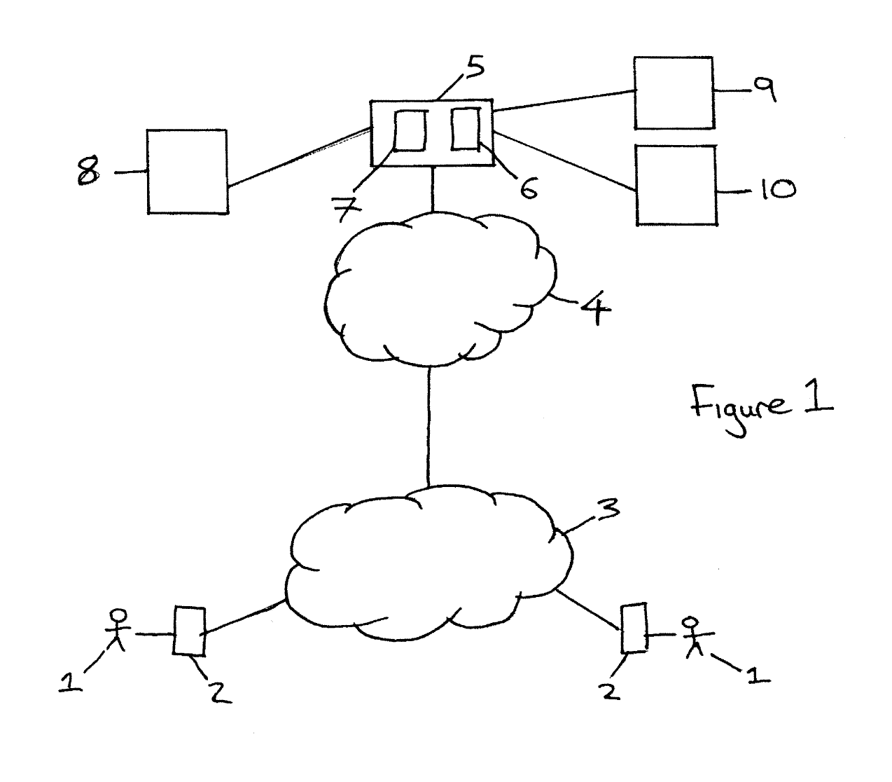

FIG. 1 shows the system according to the preferred embodiments.

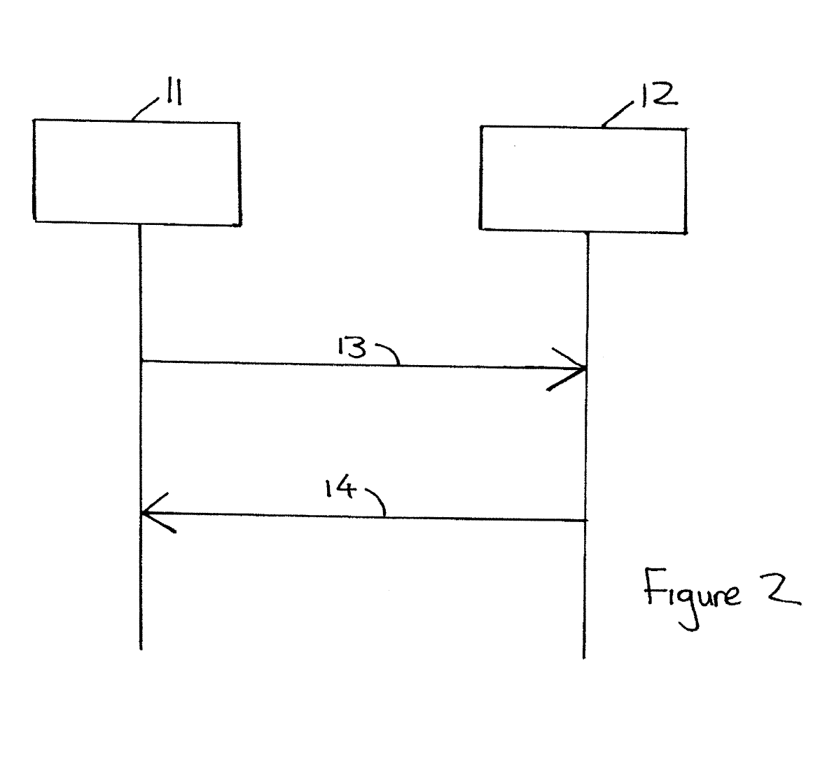

FIG. 2 shows a flow diagram when the group communication server processes a search request in accordance with the preferred embodiments.

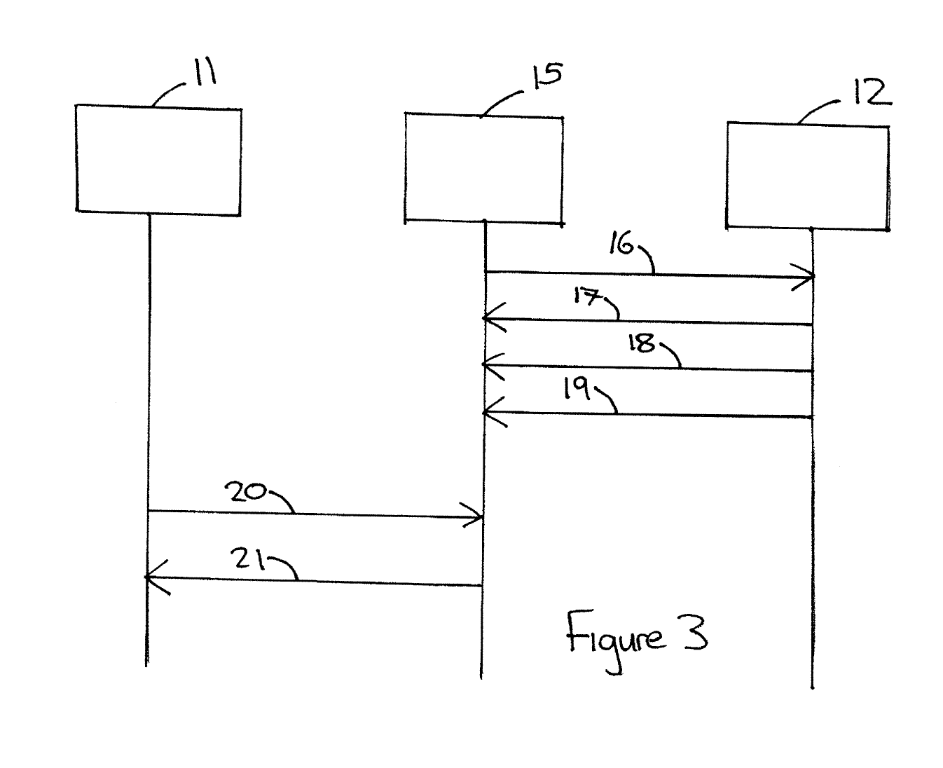

FIG. 3 shows a flow diagram when a caching entity processes a search request in accordance with the preferred embodiments.

Referring to FIG. 1, the system for providing the group communication in accordance with the preferred embodiments comprises multiple users 1 each using a terminal 2, which in the preferred embodiments are mobile communication devices (e.g. mobile phones), a communication network 3, such as a mobile communication network, a computer network 4, such as the Internet, a shared group XMDS 7, a Search Proxy 6 and any number of group communication servers 8, 9, 10. The group communication servers can be any number of a PoC server 8, an IM server 9 and a CPM server 10. The shared group XDMS 7 and the Search Proxy 6 are preferably in a control centre 5 with any other servers required, for example, an XDM Client (not shown), an Aggregation Proxy (not shown) in order to provide the group communication. However, as will be appreciated the shared group XDMS server 7, the Search Proxy 6 and any further servers may be arranged separately or in any arrangement as required.

The preferred embodiments of the present invention will now be described, by way of example only, in relation to PoC group communication using a PoC server 8. However, as would be appreciated by a person skilled in the art the preferred embodiments described also relate to IM group communication using an IM server 9 and CPM group communication using a CPM server 10. Therefore, in the following description of the preferred embodiments the features performed by a PoC server 8 can equally be performed by an IM server 9 and a CPM server 10.

The shared group XMDS 7 stores XML documents that include data on each group, for example, a Uniform Resource Identifier (URI) and a subject. The data is stored as group definitions which comprise all of the group's properties and parameters such as a member list, a subject, access rules, and so on.

An XML Document Manager (XDM) provides functionality to search the data stored as XML documents on the XDMS 7 using the protocol Limited XQuery over HTTP. An Application Usage is defined for each search function and includes several parameters to define the search capabilities. For example, the search capabilities may include:
An input collection function—which identifies the collection of data that is to be searched.
A basic XQuery expression—which may restrict the search and defines the data that should be returned as a result.
Possible restrictions on the condition used for search.

In the preferred embodiments a new Application Usage is defined that enables a user to search for active group sessions based on the subject of the group. The Application Usage is identified by an Application Unique Identity (AUID), for example: org.openmobilealliance.session-search.

To enable the XDM Client to identify the data collections that are to be searched a more detailed optional service parameter may be used, for example:
org.openmobilealliance.session-search?service=PoC—identifies that the search is for active PoC group sessions.
org.openmobilealliance.session-search?service=IM—identifies that the search is for active IM group sessions.
org.openmobilealliance.session-search?service=CPM—identifies that the search is for active CPM group sessions

If a combination of different types of active group sessions are to be searched then the service parameter may include more than one entry divided by comma, for example, “ . . . ?service=PoC, IM” identifies that the search is for active PoC and IM group sessions but not CPM group sessions. If no service parameter is provided then all of the available different types of active group sessions will be searched. Accordingly, any combination of the different types of active group sessions can be searched on any group communication server using the Application Usage of the preferred embodiments.

The PoC server 8 stores and maintains information regarding the currently active group sessions. A group session becomes active when at least one user 1 has joined the group session using their mobile phone 2 and is therefore actively participating in the group. In the preferred embodiments, when the group session becomes active the PoC server 8 retrieves a summary of the complete group definition from the shared group XDMS server 7. The group definition summary retrieved for an active group session by the PoC server 8 includes the group URI and the group subject. The group definition summary retrieved from the shared group XDMS 7 will be in the form:

<group uri=“groupl@example.com”>
<subject>sport</subject>
</group>

The PoC server 8 will store the retrieved group definition summaries in a suitable form, for example, in a list or an XML document. The XML document may be permanently stored and maintained, or the XML document may be a virtual XML document meaning that the XML document is created and populated when a search request from a user 1 is received. When the XML document is created the PoC server 8 adds the retrieved group definition summaries to the XML document. In order to ensure the XML document only contains the group definition summaries of active group sessions it is preferable that once a group session becomes inactive, where no users are actively participating in the group session, the group definition summary corresponding to the inactive group session is removed from the XML document.

According to XDM procedures any search request received is routed to a Search Proxy 6. The search request is received by the Search Proxy 6 from a user 1 preferably via an XDM Client and an Aggregation Proxy. The user 1 specifies in the search request a subject so that the user 1 can be notified of any active group sessions that correspond to the specified subject. For example, if the user 1 wishes to know if there are any active group sessions relating to sport then the user 1 would specify the subject as sport in the search request.

With reference to FIG. 2, based on the AUID, which is used as the input collection function of the search request, a Search Proxy 11 forwards 13 the search request to at least one group communication server 12 (PoC server and/or IM server and/or CPM server) depending on the parameters of the search request. The group communication server 12 providing the group communication receives the search request and the group communication server then acts as a limited XDMS in order to perform the search and identify any active group sessions that correspond to the search request.

For example, the group communication server 12, e.g. a PoC server 8, on receipt of the search request can then search the XML document which contains a list of group definitions of all active group sessions. The results of the search are then returned 14 to the Search Proxy 11 and those search results are then forwarded to the user 1 requesting the search.

Accordingly, in this embodiment, the user 1 can advantageously search the group communication server for active group sessions having a particular subject which overcomes the disadvantages and drawbacks of the conventional systems.

The number of active group sessions may be very high and the number of results obtained from a particular search may be substantial which may cause the group communication server 12, e.g. the PoC server 8, to be overloaded when performing the search request which will result in a reduced performance of the group communication sever 12.

Therefore, in a further embodiment, a projected search load is determined and if the search load is above a predetermined threshold then a caching entity can be used to process the search request so that the group communication server 12 is not overloaded.

The projected search load can be determined by many different methods either independently or in any combination thereof. For example, if the XML document containing the group definition summaries of the active group sessions changes (e.g. a group session becomes active or inactive) more frequently than it is searched then it is more efficient to perform the search on the group communication server. However, if the XML document is searched more frequently than it is changed then it is more efficient for the caching entity to perform the search.

Another method could be, for example, determining a search request queue overload condition. Newly arriving search requests are put into the request queue either in the group communication server or in the caching entity. When the request queue becomes too long an overload condition is triggered and this can be used to determine the search load and whether the group communication server or the caching entity should process the search request. The number of requests in the request queue that causes an overload condition is configurable.

In one embodiment the caching entity receives the search request from the Search Proxy 11. If the caching entity determines that the projected search load in processing the search request is above a predetermined threshold or it is more efficient for the caching entity to process the search request then the caching entity is used to obtain the search results. However, if the caching entity determines that the projected search load is below a predetermined threshold then the caching entity can forward the search request to the appropriate group communication server 12, e.g. a PoC server 8, so that the group communication server 12 can process the search request and obtain the search results.

In another embodiment, the group communication server (or a special component of the group communication server called a watchdog) receives all of the search requests and the group communication server determines whether the group communication server or the caching entity will process the search request.

Alternatively, it will be appreciated by a skilled person in the art that either the caching entity or the group communication server may process all of the search requests irrespective of the determined projected search load.

With reference to FIG. 3, if the caching entity 15 is to be used to process the search request then the caching entity 15 acts as an XDM Client and caches the changes in the XML document the group communication server 12, e.g. the PoC server 8, maintains. In other words the caching entity subscribes to the XML document maintained by the group communication server 12. The group communication server 12 therefore acts as an XDMS supporting the functionality of sending the initial XML document to the caching entity and notifying the caching entity 15 of any changes in the XML document.

As described hereinabove, the XML document maintained by the group communication server 12 may be a permanent XML document, a temporary XML document created for the search request or a virtual XML document as long as the XML document represents the actual data about the active group sessions. As described hereinabove the XML document is constructed as a list of group definition summaries of active group sessions where the group definition summary includes the active group session's URI and subject.

The caching entity 15 informs 16 the group communication server 12 that it is to start caching the group definition summaries of active group sessions and to subscribe to the XML document that the group communication server 12 maintains. The group communication server 12 sends 17 the initial XML document to the caching entity 15.

Using the xcap-diff event package together with xml-patch [RFC5261—see http://www.ietf.org/rfc/rfc5261.txt] operations the group communication server 12, e.g. the PoC server 8, sends 18 to the caching entity the group definitions of newly active group sessions which the caching entity 15 adds to the cached XML document. The group communication server 12 also preferably informs 19 the caching entity to remove any group sessions that become inactive from the cache.

The caching entity 15 can start and stop caching dynamically, based on the actual load. It can also use further optimizations, like filtering of the data provided in the notifications (e.g. cache only activity of specific groups based on their URIs or subjects).

Therefore, the caching entity 15 can process the search request 20 received from the search proxy 11 and searches the XML document maintained in the cache in order to identify the active group sessions that correspond to the subject that the user 1 has specified. The identified active group sessions that correspond to the subject that the user 1 has specified are then returned 21 to the Search Proxy 11 which forwards them to the user 1.

Accordingly, in this embodiment, the user 1 can advantageously search for active group sessions having a particular subject which overcomes the disadvantages and drawbacks of the conventional systems. This embodiment advantageously further provides a smoother load balancing in performing the search for active group sessions with a given subject specified by the user by providing a caching entity which can process the search request of the determined search load is above a predetermined threshold.

As described above, the system for providing the group communication may include more than one group communication server. In such an arrangement the group communication servers are running in parallel, none of them having a complete picture on all the active group sessions but processing the active group sessions that they are responsible for. In such an arrangement an aggregation point or aggregation proxy is used so that a complete picture of all the active group sessions can be obtained. The caching entity may be used as such an aggregation point where the caching entity may obtain the group definition summaries of the currently active group sessions from all of the group communication servers running in parallel. The aggregation point enables the user to be able to search all of the active group sessions.

In the preferred embodiments of the present invention the server providing the group communication (PoC Server, IM Server, CPM Server) maintains a virtual XML document of active group sessions. The group communication server provides a search capability in the same manner as an XDMS or the group communication server notifies changes in the XML document to the caching entity which can also provide a search capability in the same way as an XDMS.

The preferred embodiments described hereinabove have been described in relation to providing the functionality and ability to enable a user to search for active group sessions in a group communication system, in particular, PoC, IM and CPM. However, as would be appreciated by a skilled person in the art the present invention is not restricted to only these embodiments as the preferred embodiments are applicable to searching for other data on different servers, for example, online users on a Presence server. Accordingly, while preferred embodiments of the invention have been shown and described, it will be understood that such embodiments are described by way of example only.

Numerous variations, changes and substitutions will occur to those skilled in the art without departing from the scope of the present invention as defined in the appended claims. Accordingly, it is intended that the following claims cover all such variations or equivalents as fall within the spirit and the scope of the invention.

1.-21. (canceled)

22. A method comprising:
retrieving a group definition summary of an active group session wherein said group definition summary comprises a group Uniform Resource Identifier and a subject;
adding said group definition summary to an XML document;
receiving a search request wherein said search request comprises a search parameter and said search parameter comprises at least one subject; and
identifying at least one group definition summary in said XML document corresponding to said at least one search parameter.

23. The method as claimed in claim 22 further comprising:
determining at least one inactive group session; and
removing said inactive group session from said XML document.

24. The method as claimed in claim 22 in which said search request is received from a search proxy and said method further comprises:
sending said identified at least one group definition summary to said search proxy.

25. The method as claimed in claim 22 in which the search parameter further comprises at least one type of active group session.

26. The method as claimed in claim 22 further comprising:
sending said group definition summary of said active group session to a caching entity.

27. The method as claimed in claim 26 further comprising:
determining at least one inactive group session; and
sending said determined inactive group session to said caching entity.

28. A server adapted to:
retrieve a group definition summary of an active group session wherein said group definition summary comprises a group Uniform Resource Identifier and a subject;
add said group definition summary to an XML document;
receive a search request wherein said search request comprises a search parameter wherein said search parameter comprises at least one subject; and
identify at least one group definition summary in said XML document corresponding to said at least one search parameter.

29. The server as claimed in claim 28 in which said server is further adapted to:
determine at least one inactive group session; and
remove said inactive group session from said XML document.

30. The server as claimed in claim 28 in which said server is any one of a Push to Talk over Cellular server, Instant Messaging server or a Converged IP Messaging server.

31. A computer program product comprising computer readable code for:
retrieving a group definition summary of an active group session wherein said group definition summary comprises a group Uniform Resource Identifier and a subject;
adding said group definition summary to an XML document;
receiving a search request wherein said search request comprises a search parameter wherein said search parameter comprises at least one subject; and
identifying at least one group definition summary in said XML document corresponding to said at least one search parameter.

32. A method comprising:
a group communication server retrieving a group definition summary of an active group session wherein said group definition summary comprises a Uniform Resource Identifier and a subject;
adding said group definition summary to an XML document;
receiving a search request wherein said search request comprises a search parameter and said search parameter comprises at least one subject; and
determining a search load;
wherein based on said search load said search request is processed by a caching entity or by said group communication server.

33. The method as claimed in claim 32 in which said caching entity processes said search request if said search load is above a predetermined threshold; and said method further comprises:
receiving said group definition summary of said active group sessions;
caching said group definition summary;
identifying at least one group definition summary in said cache corresponding to said at least one search parameter; and
returning said identified at least one group definition summary in response to said search request.

34. The method as claimed in claim 33 further comprising:
receiving a group definition summary of an inactive group session; and
removing said group definition summary of said inactive group session from said cache.

35. The method as claimed in claim 32 in which said group communication server processes said search request if said search load is below a predetermined threshold; and said method further comprises:
identifying at least one group definition summary in said XML document corresponding to said at least one search parameter; and
returning said identified at least one group definition summary in response to said search request.

36. The method as claimed in claim 32 further comprising:
determining at least one inactive group session; and
removing said inactive group session from said XML document.

37. A system comprising:
a group communication server and a caching entity wherein said system is adapted such that:
said group communication server retrieves a group definition summary of an active group session wherein said group definition summary comprises a Uniform Resource Identifier and a subject and add said group definition to an XML document; and
said system is further adapted to:
receive a search request wherein said search request comprises a search parameter and said search parameter comprises at least one subject; and
determine a search load wherein based on said search load said search request is processed by said caching entity or by said group communication server.
